(19) United States
(12) Patent Application Publication
(10) Pub. No.: US 2019/0351720 A1
(43) Pub. Date: Nov. 21, 2019

(54) COUPLER

(71) Applicant: Alan Murray, Brookings, OR (US)

(72) Inventor: Alan Murray, Brookings, OR (US)

(21) Appl. No.: 15/985,401

(22) Filed: May 21, 2018

(51) Int. Cl. B60D 1/40; B60D 1/155; B60D 1/46; B60D 1/52

(52) U.S. Cl. CPC B60D 1/40; B60D 1/155; B60R 9/06; B60D 1/52; B60D 1/46

(57) ABSTRACT

Channel shaped receiver with side walls formed with through bores.

### CROSS-REFERENCE TO RELATED APPLICATIONS

This application is a related to U.S. application Ser. No. ______, entitled “Hitch-Mounted Carrier Device” filed May 21, 2018 and U.S. application Ser. No. ______, entitled “Collapsible Carrier Rack” filed May 21, 2018, the entireties of which are hereby incorporated herein by reference.

### BACKGROUND OF THE INVENTION

### Field of the Invention

The present invention relates generally to coupling devices and has particular application as a trailer hitch coupler.

### Description of the Prior Art

Many different types of coupling devices have been proposed for quick attachment and release. Examples are bicycle racks mounted from vehicle trailer hitches, including trailer hitches configured with rearwardly opening tubes having bores in the sidewalls thereof for receiving connector pins projected transversely through the hitch receiver. A device of this general type is shown in U.S. Pat. No. 6,902,181 to Dye, U.S. Pat. No. 8,333,402 to Moore and U.S. Pat. No. 9,713,989 to Anton.

While having certain utility for quick connection and disconnection, such devices generally present some challenge to couple and incorporate multiple loose components, components which may be disassociated, lost or misplaced when the device is removed from the trailer hitch.

Commonplace in this art are telescoped tubular hitches and tongues employing cross pins which might include an enlarged head on one extremity and a cross bore on the opposite end for receipt of a cotter pin or the like. Such devices are notorious for presenting challenges in seeking to connect and disconnect and are recognized by those in the art as often leading to pinched fingers, blood blisters, cuts, abrasions and the like during installation and removal thereof.

Moreover, any workman will testify to the frustrations stemming from loss of the various ones of disassociated components thereby making coupling impossible and delaying completion of the task at hand.

### SUMMARY OF THE INVENTION

The coupler of the present invention includes a receiver including an upwardly opening channel and a forward extremity sized to be telescopically received in a rearwardly opening tubular hitch having bores in the opposite side walls thereof. The receiver mounts at its rearward extremity a stem constructed to, in its collapsed position be received, at least partially, in the channel and having, at a distal extremity, a carrier device for carrying a bicycle or the like.

The receiver mounts a pair of elongated leaf springs in cantilever fashion from the inner surfaces of its side walls to carry, at their free ends, respective locking buttons which selectively project through the receiver bores and hitch bores to releaseably latch the receiver in the hitch.

### BRIEF DESCRIPTION OF THE DRAWINGS

FIG. 1 is a perspective view of a vehicle with a bicycle rack coupled to the trailer hitch by an embodiment of the coupler of present invention;

FIG. 2 is a perspective view of the coupler device shown in FIG. 1 but in enlarged scale;

FIG. 3 is a partial perspective view taken from the circle 3 in FIG. 2;

FIG. 4 is a longitudinal sectional view the coupler shown in FIG. 3;

FIG. 5 is a longitudinal sectional view, in enlarged scale, similar to FIG. 4 but with the lock buttons depressed;

FIG. 6 is a perspective view similar to FIG. 2 but with the receiver collapsed against a stem; and

FIG. 7 is a partial perspective view of a second embodiment of the coupler of the present invention.

### DETAILED DESCRIPTION OF THE PREFERRED EMBODIMENTS

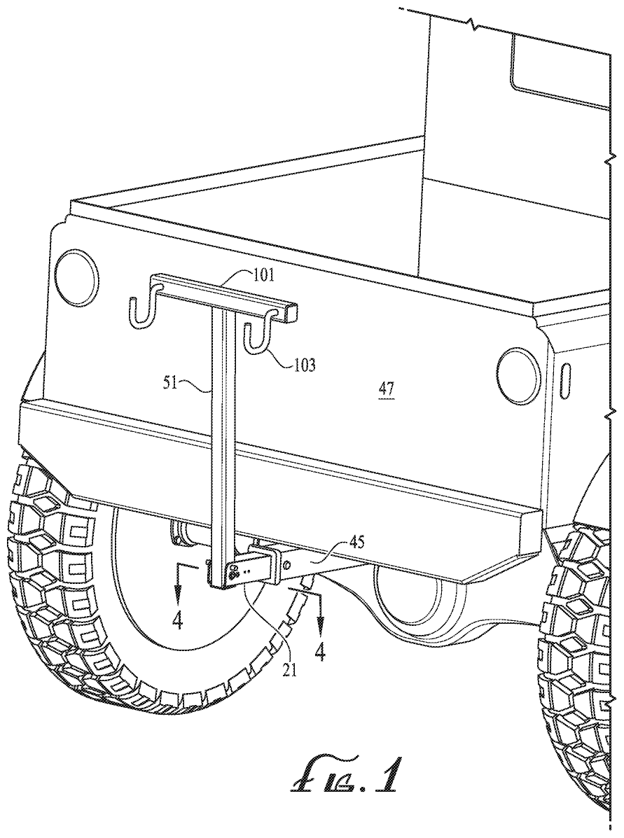

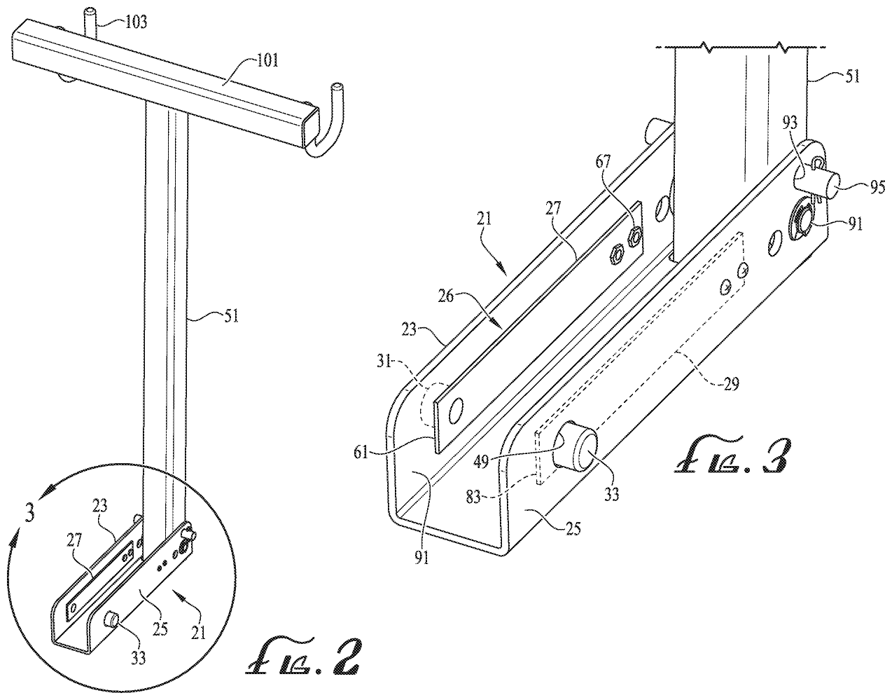

Referring to FIGS. 1, 4 and 5, the coupler of the present invention includes, generally, a receiver 21 having side walls 23 and 25 and a locking device, generally designated 26. For one embodiment, the locking device includes a pair of elongated leaf springs 27 and 29 mounted on one end from the respective side walls and formed with free ends carrying laterally outwardly directed locking buttons 31 and 33 which, when released, engage hitch bores 35 and 37 in a hitch 39 (FIG. 4).

Many different types of coupling mechanisms have been proposed but a need remains for a robust coupler which is convenient to operate and highly reliable for carrying heavy loads.

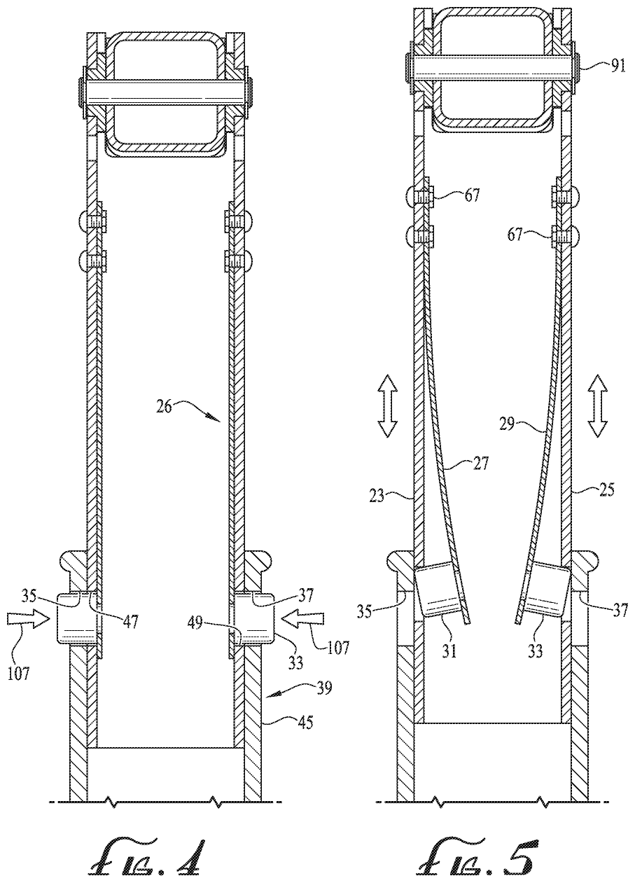

The coupler of the present invention has particular utility for coupling to a tubular hitch 45 at the rear of a vehicle 47 to support a stem 51 of a bicycle rack or the like. Referring to FIGS. 3-5, the receiver 21 is preferably channel shaped to be formed with an upwardly opening channel 61. Preferably, the side walls 23 and 25 are formed at their forward extremities with the respective bores 47 and 49 for selective receipt of the respective buttons 31 and 33. In some embodiments, the locking device includes a single leaf spring and lock buttons. Also, as will be appreciated, for some coupling devices, the locking device 26 may be mounted to the exterior of the female coupling member, shown here for exemplary purposes, as a tubular hitch 45.

The leaf springs 27 and 29 are cantileverly mounted at their rear extremities by means of mounting bolts 67 and are juxtaposed the lengths of the respective walls 23 and 25 to be biased at their respective free extremities 81 and 83 laterally outwardly against the interior surface of such walls 23 and 25. The walls 23 and 25 are formed at their rear extremities with respective bores mounting a pivot pin 91 (FIG. 3) and are further formed there above with respective bores 93 for receipt of a locking pin 95 to selectively lock the stem 51 in its erect position.

While the coupler of the present invention has many different applications and advantages, in my exemplary disclosure, I show the stem 51 as mounting a crossbar 101 at the top end thereof to carry respective upwardly opening hooks 103 to which a bicycle frame or the like may be secured for convenient carrying from the hitch of the vehicle 47.

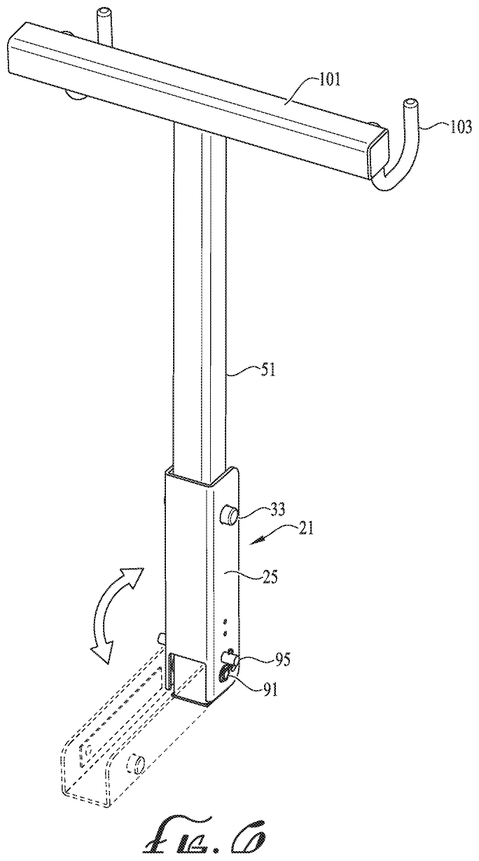

In operation, the coupler of the present invention may be easily and quickly coupled to the vehicle hitch 45 by the operator pressing the locking buttons 31 and 33 laterally inwardly so that the lateral outer surface thereof will clear the interior surfaces of the lateral walls of the hitch 45 to slide there along as shown in FIG. 5 until the buttons register with the respective bores 35 and 37 in the hitch. The leaf springs 27 and 29 will then be operative to bias the locking buttons laterally outwardly to the position shown in FIG. 4 to project through the respective bores 35 and 37 thereby coupling the receiver securely to the hitch. It will be appreciated that with the close fit telescopical arrangement, when loads are then applied to the stem 51 or forces are applied which tend to draw the receiver forwardly or rearwardly, the forces on the buttons 31 and 33 will be placed in sheer FIG. 4 to provide a secure and positive locking to the hitch. For example, when the receiver is drawn in the rearward direction, the buttons 31 and 33 will be driven against the rearward circumference of the respective bores 35 and 37 in the hitch such that those circumferential surfaces act as forwardly facing shoulders to block rearward travel of the receiver.

When it is desirable to uncouple the coupler the locking buttons 31 and 33 may be pressed laterally inwardly in the direction of the arrows 107 (FIG. 4) to thus drive such buttons laterally inwardly to the point where they clear the walls of the hitch to free the receiver for sliding forwardly and rearwardly within such hitch.

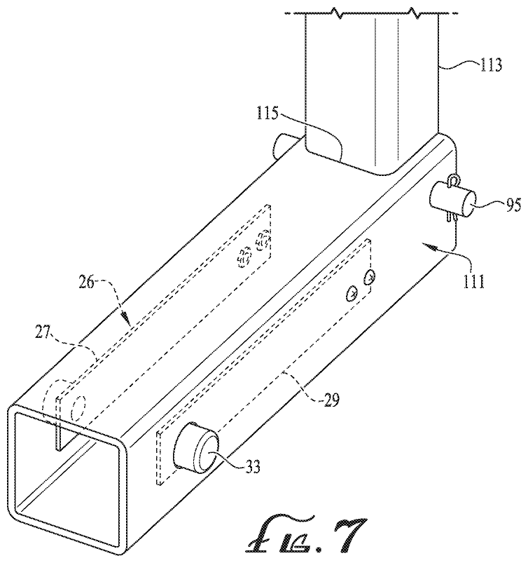

The receiver may thus be drawn from the hitch, and the pin 95 (FIG. 3) removed from the bores 93 and corresponding bores in the stem 51 to free the forward extremity of the receiver to rotate upwardly to the solid line position shown in FIG. 6. As will be appreciated by those skilled in the art, the receiver is constructed such that the walls 23 and 25 have sufficient clearance on the opposite sides of the stem 51 to allow for the respective leaf springs 27 and 29 when the coupler is in its folded position shown in FIG. 6.

The coupler device shown in FIG. 7 is similar to that shown in FIG. 3 except that the receiver 111 is tubular shaped with a closed top so that the stem 113 will be received in an upwardly opening square window 115 to be locked in place by the pin 95 when in the erect position.

In one embodiment of the present invention, the coupler includes first and second coupler components to be coupled together with a locking device 26 mounted at one end to releasably lock to the other. Typically walls comparable to the side walls of the hitch 45 and juxtaposed wall 23 or 25 will include bores having one side thereof defining a blocking shoulder to be engaged by a locking button to block relative travel between the coupling components.

From the foregoing it will be appreciated that the coupler of the present invention provides a rugged and reliable means for coupling components together with a locking mechanism that is convenient to operate without exposing the user to unnecessary injury from the task of inserting connector bolts and the like. The components of the coupler are permanently attached together thus avoiding the plague of lost components and the required replacement from time to time.

1-4. (canceled)

5. The coupler apparatus of claim 6 wherein:
the receiver is channel shaped to from a channel and constructed to be rotated to a retracted position receiving a portion of the stem nested in the channel.

6. A hitch coupler apparatus for mounting a carrier and comprising:
a tubular trailer hitch mounted to a vehicle formed with a tunnel having a rearward opening and including opposite planer side walls formed with hitch bores;
a receiver formed to be received slidably in the tunnel of the tubular hitch to a locking position to support the carrier;
the receiver including opposite walls formed with aligned receiver bores to be, when the receiver is received slidably in the hitch, registered with the respective hitch bores;
the receiver further including a pair of elongated leaf springs having respective mounting extremities mounted to the interior surfaces of the respective opposite walls and having respective free extremities mounting respective outwardly projecting lock buttons to, when the leaf springs are juxtaposed the respective walls and the receiver bores registered with the respective hitch bores, project laterally outwardly through the respective receiver bores and through the hitch bores.

7-10. (canceled)

11. A coupler apparatus to be mounted to a rearwardly opening horizontal tubular trailer hitch formed with a tunnel having oppositely disposed vertical hitch side walls formed with hitch bores and comprising:
an elongated upstanding stem formed with a predetermined rectangular, transverse cross section having opposite lateral sides;
a receiver having forward and rearward extremities and constructed in the form of a receiver channel having channel side walls and configured to be selectively received over the upstanding standing stem with the channel side walls in complimentary, close fit relationship with the opposite lateral side walls, the receiver also constructed for receipt of the forward extremity in the tunnel to be shifted to a forward-locking position;
the channel side walls formed with receiver bores to be, when the hitch is in the forward locking position, aligned with the hitch bores;
locking buttons to when the hitch and receiver bores are aligned, project through the hitch and receiver bores to block horizontal shifting of the receiver relative to the hitch; and
elongated leaf springs positioned on the inside surfaces of the channel side walls and having fixed and free extremities, the fixed ends affixed to the channel side walls and the free extremities mounting the respective buttons, the free extremities and being constructed for carrying the respective buttons through respective paths from release positions disengaged from the respective hitch bores and locking positions projected through the respective hitch and receiver bores.

12. A hitch coupler apparatus for mounting a carrier and comprising:
a tubular trailer hitch mounted to a vehicle, formed with a tunnel having a rearward opening and including opposite planer side walls formed with hitch openings;
a receiver formed to be received slidably in the tunnel of the tubular hitch to a locking position to support the carrier;
the receiver including opposite walls formed with receiver openings to be, when the receiver is received slidably in the hitch, registered with the respective hitch openings;
the receiver further including a pair of elongated leaf springs having respective mounting extremities mounted to the interior surfaces of the respective opposite walls and having respective free extremities mounting respective outwardly projecting lock buttons to, when the receiver openings registered with the respective hitch openings, project laterally outwardly through the respective receiver openings and into the hitch openings.
